(19) United States
(12) Patent Application Publication
(10) Pub. No.: US 2009/0023026 A1
(43) Pub. Date: Jan. 22, 2009

(54) Metal separator for fuel cell

(75) Inventors: Sang Mun Chin, Gyeonggi-do (KR); Yoo Chang Yang, Gyeonggi-do (KR); Sae Hoon Kim, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/005,867

(22) Filed: Dec. 28, 2007

(30) Foreign Application Priority Data
Jul. 20, 2007 (KR) 10-2007-0072516

(51) Int. Cl. H01M 8/02

(52) U.S. Cl. 429/26

(57) ABSTRACT

The present invention provides a metal separator for a fuel cell, which is formed by stamping molding a first metal thin plate and a second metal thin plate, the metal separator comprising: at least one cooling flow field enclosed by inner surfaces of the first and second metal thin plates; first and second main flow fields enclosed by outer surfaces of the first and second thin plates, respectively; and first and second auxiliary flow fields formed on a top surface of the first main flow field and a bottom surface of the second main flow field, respectively.

### CROSS-REFERENCE TO RELATED APPLICATION

This application claims under 35 U.S.C. §119(a) on Korean Patent Application No. 10-2007-0072516, filed on Jul. 20, 2007, the entire contents of which are incorporated herein by reference.

### BACKGROUND

(a) Technical Field

The present invention relates to a metal separator for a fuel cell. More particularly, the present invention relates to a metal separator for a fuel cell with an improved structure in which auxiliary flow fields are provided to reduce a flooding phenomenon in a polymer electrolyte membrane fuel cell.

(b) Background Art

A polymer electrolyte membrane fuel cell (PEMFC) is a device that generates electricity and forms water by an electrochemical reaction between hydrogen and oxygen. The PEMFC can be applied to various fields such as a zero-emission vehicle, an independent power plant, a portable military power source, and the like, due to its advantages such as higher fuel efficiency, higher current density, higher output density, shorter startup time, and faster response characteristics than other types of fuel cells

In the PEMFC, a membrane electrode assembly (MEA) is positioned at the most inner portion, the MEA including a solid polymer electrolyte membrane capable of transporting hydrogen protons, and catalyst layers, i.e., an anode and a cathode, formed on both sides of the electrolyte membrane to allow hydrogen and oxygen to react with each other.

Moreover, a gas diffusion layer (GDL) is positioned outside the MEA, i.e., on the surface where the cathode and the anode are positioned, and a separator having flow fields for supplying fuel and exhausting water produced by the reaction is positioned outside the GDL.

Accordingly, an oxidation reaction of hydrogen occurs at the anode of the fuel cell to produce hydrogen ions and electrons. The thus produced hydrogen ions and electrons are transferred to the cathode through the polymer electrolyte membrane and a conducting wire, respectively.

At the same time, a reduction reaction of oxygen occurs at the cathode receiving the hydrogen ions and electrons from the anode to produce water. Here, electrical energy is generated by the flow of the electrons through the conducting wire and by the flow of the protons through the polymer electrolyte membrane.

In general, the separator is formed of a graphite material and includes flow fields formed by a mechanical process. As shown in FIG. 5, the conventional graphite separator 200 is disposed outside the GDLs 12 positioned on both sides of the MEA 10 and includes cooling flow fields and main flow fields.

Auxiliary flow fields are formed in a concave groove shape on the top surface of the main flow fields of the graphite separator 200 in order to maintain the strength thereof and facilitate the discharge of droplets. However, the auxiliary flow fields increase the thickness of the separator and reduce the strength thereof, compared with the separator without the auxiliary flow fields.

Moreover, the conventional graphite separator is accompanied with various problems. i.e., it requires high manufacturing cost, and it is difficult to form the separator itself to be a thin plate. In case of a graphite separator having a high brittleness, a partition of more than 2 mm is formed between the main flow fields to maintain the strength thereof, thus resulting in an increase in thickness of the separator.

In order to solve such problems, the separator is formed of a metal material having excellent strength and facilitating the formation of a thin plate.

As shown in FIG. 6, a conventional metal separator 300, including main flow fields and cooling flow fields, is formed of a metal thin plate having a thickness of 0.1 to 0.2 mm by a molding process such as stamping. The metal separator 300 has advantages in that the manufacturing time and cost are remarkably reduced compared with the graphite separator in which the flow fields are formed by a mechanical process.

However, in the case of the metal separator including the flow fields formed of a metal thin plate having a thickness of 0.1 to 0.2 mm by a molding process such as stamping, it is difficult to process the auxiliary flow fields directly onto the metal thin plate.

That is, since the existing metal separator has a structure in that an anode flow field and a cathode flow field are directly in contact with the bottom surface thereof, it is very difficult to process the auxiliary flow fields on the bottom surface of the metal thin plate like the graphite separator.

In a case where the auxiliary flow fields are not formed on the metal separator, it is very vulnerable to a “flooding” phenomenon.

The flooding phenomenon is caused when water produced by a chemical reaction of the reaction gas is condensed but not discharged to the outside. The condensed water obstructs the reaction gas from diffusing, thus reducing the efficiency of the fuel cell. Accordingly, the reduction of the flooding phenomenon in the fuel cell stack is one of the most significant technologies to improve the performance of the fuel cell.

Here, the reason why the flooding phenomenon occurs will be described briefly.

The electrochemical reactions in the polymer electrolyte fuel cell (PEFC) include the oxidation reaction at the anode and the reduction reaction at the cathode.

At this time, the water produced by the electrochemical reaction and the water transported from the anode by electroosmosis are excessively present in the cathode. A portion of the excessive water is evaporated into the reduction gas (oxygen or air) flowing in a channel of the separator to saturate the reduction gas, and the residual water not evaporated is present in the liquid state in the GDL or in the channel of the separator.

Accordingly, if the excessive water present in the GDL or in the channel of the separator is not discharged to the outside by a proper instrument, it causes the flooding phenomenon that results in a serious problem in the performance and reliability of the fuel cell.

The information disclosed in this Background section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems, and an object of the present invention is to provide a metal separator for a fuel cell with an improved structure in which auxiliary flow paths are formed on main flow fields only by modifying a mold in a stamping process to reduce a flooding phenomenon caused when excessive water present in a gas diffusion layer of the fuel cell or in a channel of the separator is not discharged to the outside.

In one aspect, the present invention provides a metal separator for a fuel cell, which is formed by stamping molding a first metal thin plate and a second metal thin plate, the metal separator comprising: at least one cooling flow field enclosed by inner surfaces of the first and second metal thin plates; first and second main flow fields enclosed by outer surfaces of the first and second thin plates, respectively; and first and second auxiliary flow fields formed on a top surface of the first main flow field and a bottom surface of the second main flow field, respectively.

In a preferred embodiment, the first auxiliary flow field is formed on a top surface of the first main flow field in a concave shape.

In another preferred embodiment, the first auxiliary flow field has a cross-section selected from the group comprising a trapezoid, an oval, a square, and a triangle, for example.

In still another preferred embodiment, the first auxiliary flow field has a cross-section selected from the group comprising a trapezoid, an oval, a square, and a triangle.

In yet a still another preferred embodiment, a first projection is formed on at least a portion of the inner surface of the first metal thin plate at a location corresponding to the top portion of the first auxiliary flow field formed in a concave shape.

In a further preferred embodiment, a projection groove is formed on at least a portion of the inner surface of the second metal thin plate at a location corresponding to the first projection such that the first projection is inserted into the projection groove.

In a still further preferred embodiment, a second projection is formed on at least a portion of the outer surface of the second metal thin plate at a location near the top portion of the first main flow field and corresponding to the projection groove and, thereby forming on both distal sides of the bottom surface of the second main flow field the second auxiliary flow field protruding downwardly with respect to the bottom surface of the second main flow field.

In yet a further preferred embodiment, the first and second auxiliary flow fields are formed continuously from inlets to outlets of the first and second main flow fields.

In another aspect, the present invention provides a fuel cell comprising the above-described metal separator.

In a preferred embodiment, the metal separator is disposed on first and second gas diffusion layers formed on both surfaces of a membrane electrode assembly, respectively, such that the first auxiliary flow field formed in one of the metal separators is disposed so as to face the first gas diffusion layer and the second auxiliary flow field formed in the other metal separator is disposed so as to face the second gas diffusion layer.

The above features and advantages of the present invention will be apparent from or are set forth in more detail in the accompanying drawings, which are incorporated in and form a part of this specification, and the following Detailed Description section, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIGS. 1 to 4 are cross-sectional views illustrating a metal separator for a fuel cell in accordance with preferred embodiments of the present invention;

FIG. 5 is a cross-sectional view illustrating a conventional graphite separator for a fuel cell; and

FIG. 6 is a cross-sectional view illustrating a conventional metal separator for a fuel cell.

Reference numerals set forth in the Drawings includes reference to the following elements as further discussed below:

| | |
|---|---|
| 10: membrane electrode assembly | |
| (MEA) | |
| 12: gas diffusion layer (GDL) | 12a: first GDL |
| 12b: second GDL | 101: first metal thin plate |
| 102: second metal thin plate | 103: cooling flow field |
| 104: first main flow field | 105: second main flow field |
| 107: first auxiliary flow field | 108: second auxiliary flow field |
| 109: first projection | 110: projection groove |
| 111: second projection | 100: metal separator |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A membrane electrode assembly (MEA) 10 includes a solid polymer electrolyte membrane capable of transporting hydrogen protons, and catalyst layers, i.e., an anode and a cathode, formed on both sides of the electrolyte membrane to allow hydrogen and oxygen to react with each other. Moreover, a gas diffusion layer (GDL) 12 is positioned outside the MEA 10, i.e., on the surface where the cathode and the anode are positioned, and a separator having flow fields for supplying fuel and exhausting water produced by the reaction is positioned outside the GDL 12.

The present invention aims at forming auxiliary flow fields on the top and bottom portions of main flow fields, simultaneously with forming the cooling flow fields, on the separator formed of two metal thin plates having a thickness of, for example, 0.1 to 0.2 mm by a stamping process.

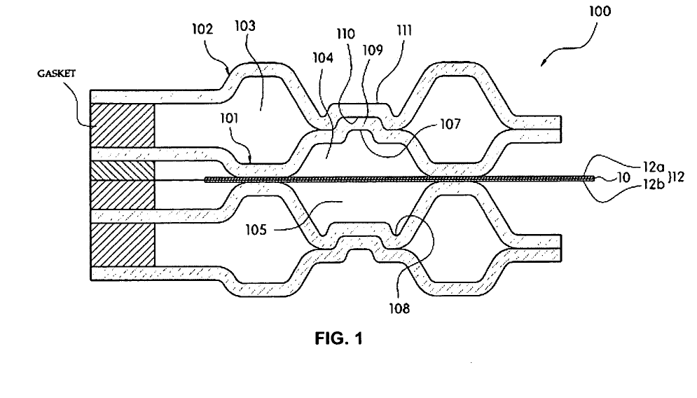

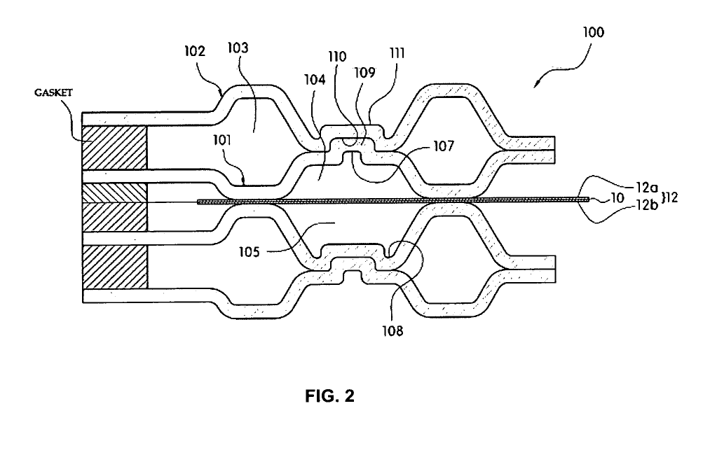

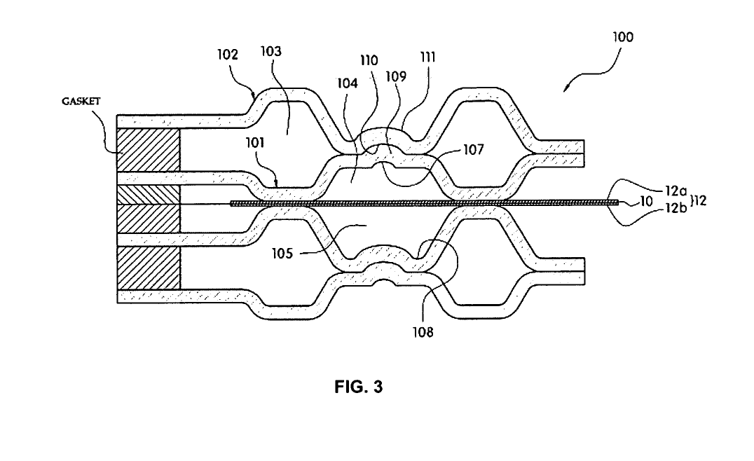

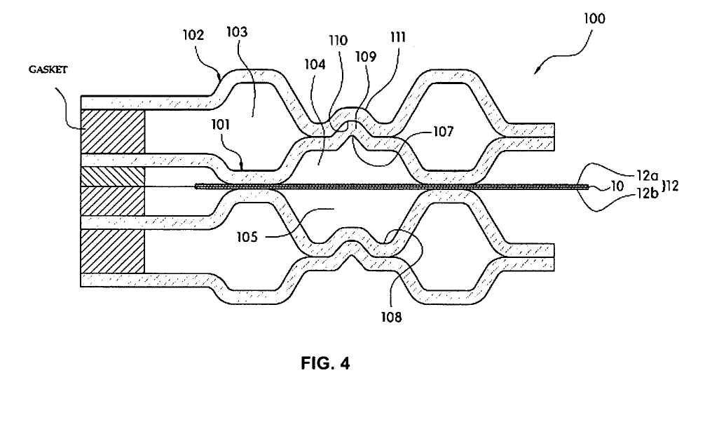

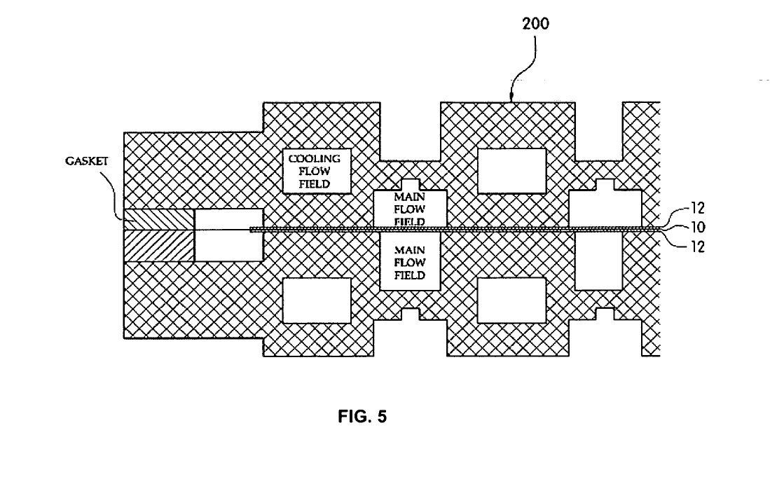

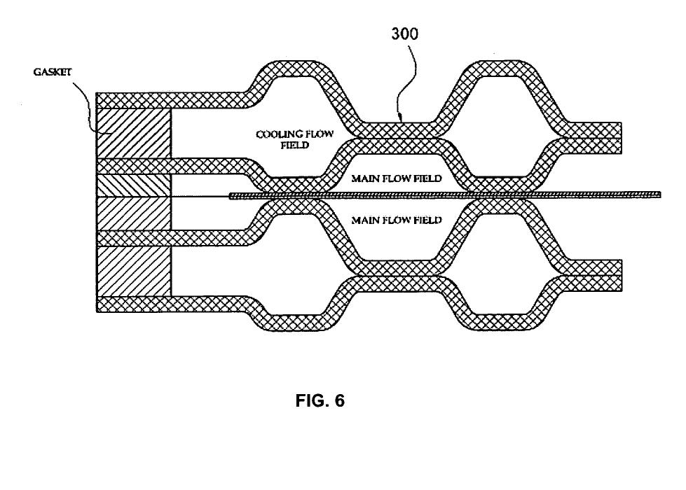

The metal separator 100 for a fuel cell of the present invention is shown in FIGS. 1 to 4. The metal separators 100 shown in the respective figures have substantially the similar structure, except for the cross-sectional shape.

The structure of the metal separator of the present invention and a method of manufacturing the same will be described in detail below.

First, the metal separator 100 is formed of two metal thin plates by a stamping process, in which a mold for the stamping process is modified to form auxiliary flow fields at the metal separator 100.

For a better understanding of the present invention, one of the two metal thin plates is referred to as a first metal thin plate 101 and the other is referred to as a second metal thin plate 102.

When the first and second metal thin plates 101 and 102 are placed on the stamping mold and subjected to the stamping process, at least a portion where the first and second metal thin plates 101 and 102 are overlapping each other is bent outwardly at the same time and thereby a space for cooling flow fields 103 is formed between the inner surfaces of the first metal thin plate 101 and the second metal thin plate 102 as shown in FIG. 1. Furthermore, a space for each of main flow fields 104 and 105 is formed in a concave shape between the cooling flow fields 103, enclosed by at least a portion of outer surface of the first and second metal thin plates 101 and 102.

In more detail, a first main flow field 104 concavely bent upwards is enclosed by a portion of the outer surface of the first metal thin plate 101, and a second main flow field 105 concavely bent downwards is enclosed by a portion of the outer surface of the second metal thin plate 102.

By the stamping process, the auxiliary flow fields 107 and 108 are formed respectively on the top and bottom portions of the first and second main flow fields 104 and 105 at the same time when the cooling flow fields 103 and the main flow fields 104 and 105 are formed on the first and the second metal thin plates 101 and 102.

That is, by one process of stamping, first and second auxiliary flow fields 107 and 108 are formed respectively on the top and bottom portions of the first and second main flow fields 104 and 105 at the same time as the first and second main flow fields 104 and 105 are formed on each outer surface of the first and second metal thin plates 101 and 102.

The structure of the auxiliary flow fields will be described in more detail below.

The first auxiliary flow field 107 is formed in a concave shape bent upwards at the portion of the first mental thin plate 101 forming the top surface of the first main flow field 104. Especially, the first auxiliary flow field 107 is formed with a cross-section selected from the group comprising a trapezoid, an oval, a square, and a triangle.

When the first auxiliary flow field 107 concavely bent is formed substantially in the top portion of the first main flow field 104 by the stamping process, the portion of the first metal thin plate 101 corresponding to the first auxiliary flow field 107 is protruded outwards to form a first projection 109.

Accordingly, the first projection 109 is formed outwards at a portion of the first metal thin plate 101 corresponding to the configuration of the first auxiliary flow field 107 concavely bent.

Meanwhile, by one process of stamping, the second main flow field 105 is also formed in a concave shape bent downwardly, enclosed by at least a portion of the outer surface of the second metal thin plate 102. A concavely-bent projection groove 110 of the second metal thin plate 102 is formed in at least a bottom portion of the second main flow field 105, complimentary to the first projection 109 of the first metal thin plate 101 such that the first projection 109 of the first metal thin plate 101 is inserted into the projection groove 110.

Accordingly, with the formation of the projection groove 110 of the second metal thin plate 102, a second projection 111 is formed substantially on the bottom portion of the second main flow field 105 complementary to the first projection 109 of the first metal thin plate 101. Both distal sides of the bottom portion of the second main flow field 105, except for the portion of the second projection 111, may form at least a second auxiliary flow field 108 wherein the second auxiliary flow field protrudes downwards with respect to the bottom portion of the second main flow field 105 to form a groove for facilitating the transfer of the droplets.

As described above, it is possible to easily manufacture the metal separator 100 including the cooling flow fields 103 for collecting heat generated by the reaction, the first and second main flow fields 104 and 105, through which the reaction gas is transferred, and the first and second auxiliary flow fields 107 and 108 for facilitating the transfer of the droplets occurring in the main flow fields to prevent the flooding phenomenon.

Especially, since the metal separator 100 of the present invention has a structure in which the first projection 109 of the first metal thin plate 101 is inserted into the projection groove 110 of the second metal thin plate 102, it is possible to more easily stack the separators and prevent the separators from slipping off each other.

As discussed above, the present invention, in another aspect, provides a fuel cell comprising the above-described metal separator.

For example, the metal separator 100 is disposed outside the GDL 12 formed on both sides of the MEA 10.

For a better understanding of the present invention, the GDL 12 formed on one surface of the MEA 10 is referred to as a first GDL 12a and that formed on the other surface of the MEA 10 is referred to as a second GDL 12b.

The metal separator 100 manufactured as described above is disposed at the outer surfaces of the first and second GDLs 12a and 12b, respectively, such that the first main flow field 104 and the first auxiliary flow field 107 in one of the metal separators 100 are disposed to face the first GDL 12a, and the second main flow field 105 and the second auxiliary flow field 108 in the other metal separator 100 are disposed to face the second GDL 12b.

Meanwhile, it is preferable that the first and second auxiliary flow fields 107 and 108 are formed continuously from inlets to outlets of the first and second main flow fields 104 and 105. Moreover, the first and second auxiliary flow fields 107 and 108 may be locally formed at a portion where the droplets are hard to transfer. Furthermore, the number of the auxiliary flow fields 107 and 108 may be increased depending on a structure in which a plurality of auxiliary flow fields is branched on the top and bottom surface of the main flow fields.

Like this, with the auxiliary flow fields having a narrow width and a small cross-sectional area simultaneously formed along the top and bottom surface of the main flow fields during the stamping process, the droplets formed in the main flow fields are rapidly transferred along the auxiliary flow fields, not obstructing the flow of the droplets along the main flow fields, thus reducing the flooding phenomenon.

As described above, the present invention provides the various advantages including the following:

1) since the auxiliary flow fields are formed on the top and bottom surface of the main flow fields of the metal separator simultaneously with the main flow fields only by modifying the mold in the stamping process, it is possible to easily form the auxiliary flow fields without a separate process;

2) with the auxiliary flow fields formed on the top and bottom surface of the main flow fields, the droplets formed in the main flow fields are rapidly transferred along the auxiliary flow fields, not obstructing the flow of the droplets along the main flow fields, thus reducing the flooding phenomenon;

3) since the auxiliary flow fields are formed simultaneously with the main flow fields in the stamping process, differently from the conventional graphite separator, it is possible to save manufacturing cost and time;

4) with the projection and the projection groove formed simultaneously with the auxiliary flow fields, it is possible to easily stack the separators and prevent the separators from slipping off each other; and

5) the auxiliary flow fields formed in a concave shape, the projection, and the projection groove can support the strength of the separator and thus prevents the fuel cell stack from being twisted and deformed.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A metal separator for a fuel cell, which is formed by stamping molding a first metal thin plate and a second metal thin plate, the metal separator comprising:
at least one cooling flow field enclosed by inner surfaces of the first and second metal thin plates;
first and second main flow fields enclosed by outer surfaces of the first and second thin plates, respectively; and
first and second auxiliary flow fields formed on a top surface of the first main flow field and a bottom surface of the second main flow field, respectively.

2. The metal separator for a fuel cell of claim 1, wherein the first auxiliary flow field is formed on a top surface of the first main flow field in a concave shape.

3. The metal separator for a fuel cell of claim 1, wherein the first auxiliary flow field has a cross-section selected from the group comprising a trapezoid, an oval, a square, and a triangle.

4. The metal separator for a fuel cell of claim 2, wherein the first auxiliary flow field has a cross-section selected from the group comprising a trapezoid, an oval, a square, and a triangle.

5. The metal separator for a fuel cell of claim 2, wherein a first projection is formed on at least a portion of the inner surface of the first metal thin plate at a location corresponding to the top portion of the first auxiliary flow field formed in a concave shape.

6. The metal separator for a fuel cell of claim 5, wherein a projection groove is formed on at least a portion of the inner surface of the second metal thin plate at a location corresponding to the first projection such that the first projection is inserted into the projection groove.

7. The metal separator for a fuel cell of claim 6, wherein a second projection is formed on at least a portion of the outer surface of the second metal thin plate at a location near the top portion of the first main flow field and corresponding to the projection groove and, thereby forming on both distal sides of the bottom surface of the second main flow field the second auxiliary flow field protruding downwardly with respect to the bottom surface of the second main flow field.

8. The metal separator for a fuel cell of claim 1, wherein the first and second auxiliary flow fields are formed continuously from inlets to outlets of the first and second main flow fields.

9. A fuel cell comprising the metal separator of claim 1.

10. The fuel cell of claim 9, wherein the metal separator is disposed on first and second gas diffusion layers formed on both surfaces of a membrane electrode assembly, respectively, such that the first auxiliary flow field formed in one of the metal separators is disposed so as to face the first gas diffusion layer and the second auxiliary flow field formed in the other metal separator is disposed so as to face the second gas diffusion layer.
